(19) United States
(12) Patent Application Publication
(10) Pub. No.: US 2002/0179786 A1
(43) Pub. Date: Dec. 5, 2002

(54) ZWJ-angle-adjustment

(76) Inventor: Wei Jie Zheng, Tokyo (JP)

Correspondence Address: WEI JIE ZHENG, NISHISHINKOIWA 1-1-1-1425, KATUSHIKAKU, TOKYO, JP

(21) Appl. No.: 09/836,482

(22) Filed: Apr. 17, 2001

(51) Int. Cl. F16M 11/02

(52) U.S. Cl. 248/178.1; 248/179.1; 248/181.1

(57) ABSTRACT

The ZWJ-ANGLE-ADJUSTMENT (Z-A-A) is a new device that is used to adjust inclination angle or rotation angle for instruments and machines. Adjustment in the two phases can be brought about individually or simultaneously by two adjust-screws of the device. Adjustment can be achieved accurately, conveniently and smoothly. Some of common angle-adjustments, for example, the sphere-joint-angle-adjustment and camera-platform, are difficult to achieve high accuracy. The others such as worm gearing can work accurately, but they are complicated and expensive. The characteristic of the presented invention is, the angle in two phases (inclination and rotation) can be adjusted accurately in one sphere-head-shaft, adjusting in each phase (goes up and down) by one screw only. So presented invention provides a small-size device of simple structure. Also, its low production cost makes mass production possible so that potential marketing benefit is considerable.

The ZWJ-ANGLE-ADJUSTMENT (Z-A-A) is a new device that is used to adjust inclination angle or rotation angle for instruments and machines. Adjustment in the two phases can be brought about individually or simultaneously by two adjust-screws of the device. Adjustment can be achieved accurately conveniently and smoothly.

### BACKGROUND OF THE INVENTION

Some of common angle-adjustments, for example, the sphere-joint-angle-adjustment and camera-platform, are difficult to achieve high accuracy. The others such as worm gearing can work accurately, but they are complicated and expensive. An angle-adjust-device is combined with one sphere head-shaft and two screws, but it can adjust inclination-angle only by four or two screws. (Refer to Japan; [symbol] 1-162973 [symbol] ). The characteristic of the presented invention is, the angle in two phases (inclination and rotation) can be adjusted accurately in one sphere-head-shaft, adjusting in each phase (goes up and down) by one screw only. So, the presented invention provides a small-size device of simple structure. Also, its low production cost makes mass production possible that potential marketing benefit is considerable.

### DETAILED DESCRIPTION OF THE INVENTION

The presented invention (Z-A-A) is a new device which can be connected to machines and instruments to adjust the angles in two phases (inclination and revolution). The adjusting scope of each phase is about 30°. Adjustment is achieved by means of an adjust-shaft. The action of the adjust-shaft is controlled by two adjust-screws. They are have special constructions. All of the elements of the Z-A-A are assembled into a box called “the body” here. The construction and steps of assembling of the basic type of Z-A-A are described detailed as follows (refer to FIG. 1 to FIG. 9);

1. Insert the adjust-shaft 9 into the body 1 from below through the hole 1a (FIG. 1). The sphere-head 9a (FIG. 7) of the adjust-shaft is in accordance with the spherical-surface 1b (FIG. 2.b) of the hole. Then the sphere is localized there by the spherical-surface-cover 2 and stop-screw 3 (FIG. 1.(a)). So that the adjust-shaft 9 is able to rotate in any direction with a limited scope.

2. Insert the adjust-lever 5 (FIG. 1) into the rectangular-hole 9b (FIG. 7) in the adjust-shaft. The adjust-lever stays in the cavity of the body and fits the hole 9b in width but is allowed to move up and down a little and can be pushed in or drawn out smoothly. Drive in the rotation-adjust-screw 12 through the screw-hole 1g (FIG. 2). Fit the sphere-head 12a of the screw (FIG. 8) with the concave-spherical-surface of the hole 5b at the end of the lever 5 (FIG. 4) carefully. By aid of the stop-ring 11 (FIG. 1,(c)), the sphere-head 12a is localized in the hole 5b but can be rotated within a limited scope.

3. Drive the inclination-adjust-screw 10 into the screw-hole 1f (FIG. 2). Put the special-bearing 6 (FIG. 5) into the cavity of body (FIG. 1). The width of the bearing fits the width of body, that is, the distance between two interior sides of body-wall le (FIG. 2). In the meantime the adjust-shaft 9 is passed through the bearing-hole 6b of the bearing 6 (FIG. 5). Fit the sphere-head 10a of the inclination-adjust-screw into the open-hole 6c carefully. Thus, driving the inclination-adjust-screw in or out results movement of the special-bearing 6 and then the adjust-shaft makes inclination along the interior sides le of the body wall (FIG. 1.(a)).

4. The cover 8 is fixed on top of body by four small screws 7 (FIG. 1(a)). A long-elliptical hole 8b (FIG. 6) is opened in the cover that is used to limit the inclination scope of adjust-shaft. Also, the cover 8 prevents the special bearing from separation with the adjust-shaft. The aperture between top of the special bearing 6 and bottom of the cover 8 keeps unchanged when the adjust-shaft is making inclination movement because the top surface 6d (FIG. 5) of the special bearing 6 is an arc and the center of the arc is coincide with the arc drawn by the adjust-shaft during its inclination movement.

5. After the device is finally installed, the adjust-shaft can be adjusted accurately inclination phase and rotation phase by turning the inclination-adjust-screw and rotation-adjust-screw respectively. The adjust-shaft can be locked by the lock-screw 4 (FIG. 1) after adjustment ends. The object to be adjusted can be connected firmly with the adjust-shaft when some accessories are properly used. Typical example is shown in FIG. 10.

Example usages of the device are as follows;

1. Angle of photograph by camera can be adjusted (Fig.10)

2. Angle of laser sensor's beam can be adjusted.

3. Angle of the telescope can be adjusted.

4. Angle of light can be adjusted.

5. Angle of reflector for cars or microscopes can be adjusted.

6. Angle of radiation from medical equipments can be adjusted.

7. Angle of nozzle can be adjusted.

8. The device can be used as a standard machine element in tool machines.

9. The device can be used in airplane or satellite profiting from its small volume.

10. Angle of TV antenna of satellite broadcast can be adjusted.

11. Angle of project can be adjusted.

12. Angle of fire of weapon such as laser gun can be adjusted.

13. If a small motor is to be installed, the device can be controlled automatically.

### BRIEF DESCRIPTION OF THE DRAWINGS

FIG. 1 ZWJ-ANGLE-ADJUSTMENT (Basic type) (a) Vertical section (b) A-A section (c) F detail, expansion (d) B-B section

FIG. 2 Body (a) Front view (b) Vertical section (c) A-A section

FIG. 3 Spherical-Surface-Cover Vertical section

FIG. 4 Adjust-lever (a) Front view (b) Side view (c) F detail, expansion

FIG. 5 Special bearing (a) Front view (b) Vertical section

FIG. 6 Cover (a) Front view (b) Vertical section

FIG. 7 Adjust-shaft (a) Front view (b) Bottom view

FIG. 8 Inclination-adjust-screw(Rotation-adjust-screw)

FIG. 9 Stop-ring (a) Front view (b) Vertical section

FIG. 10 ZWJ-ANGLE-ADJUSTMENT (Compound type) (a) Vertical section (b) Bottom view

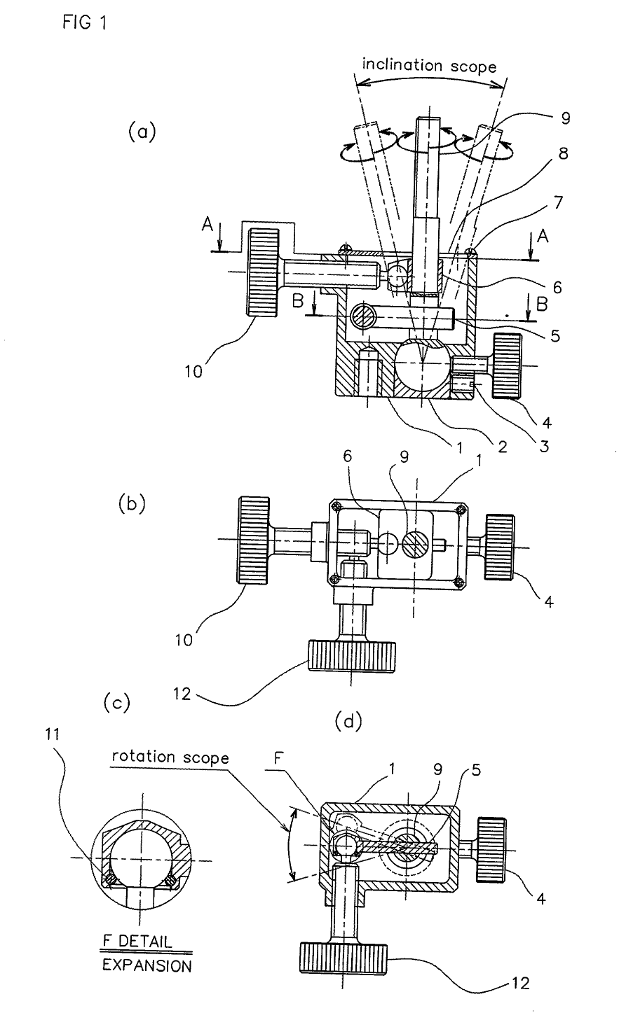

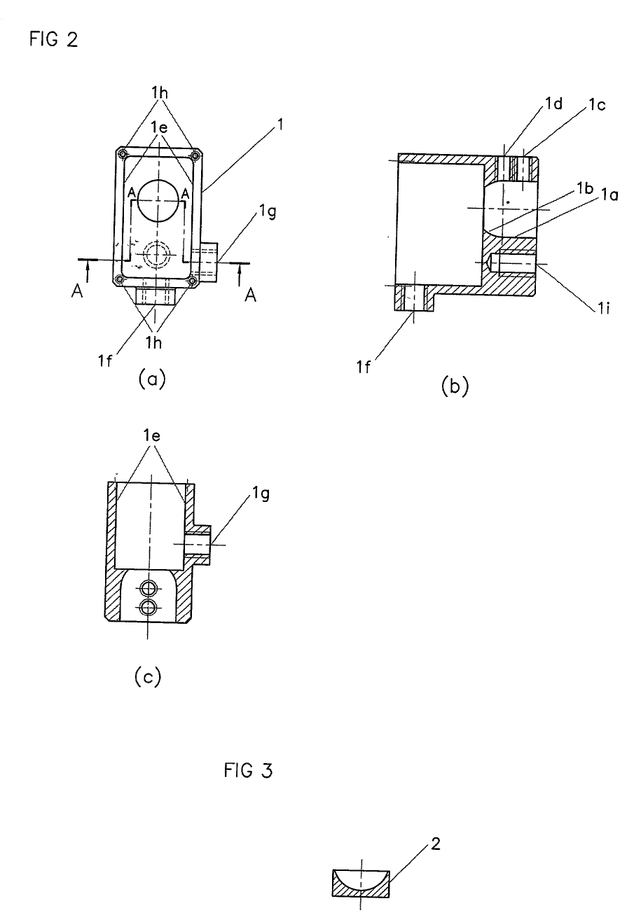

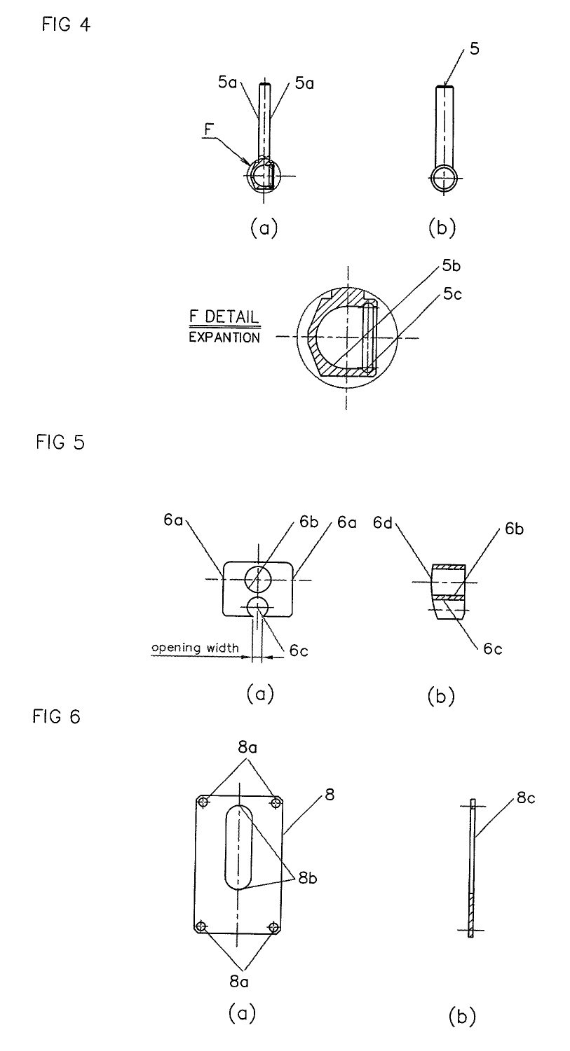

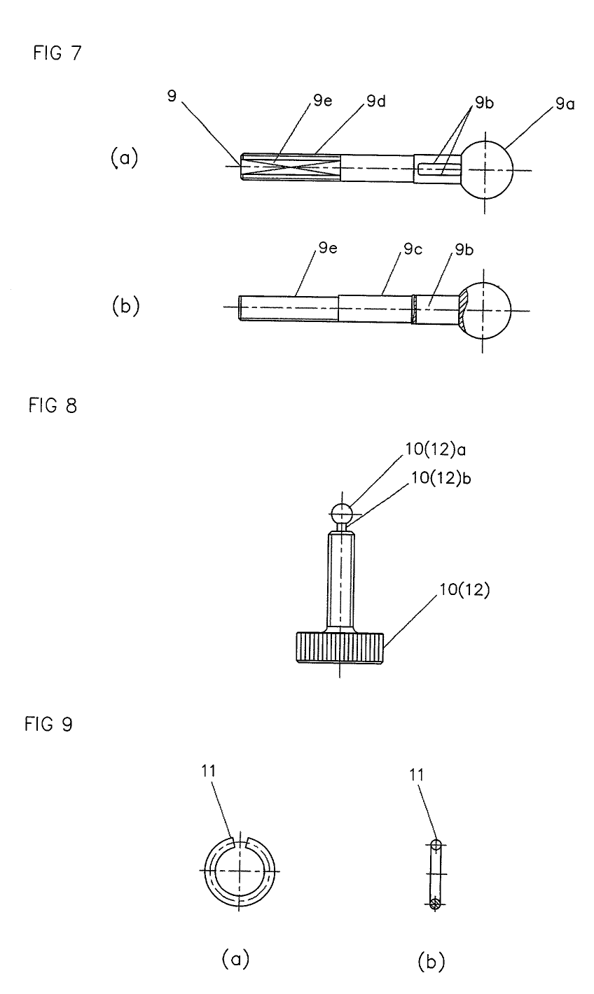

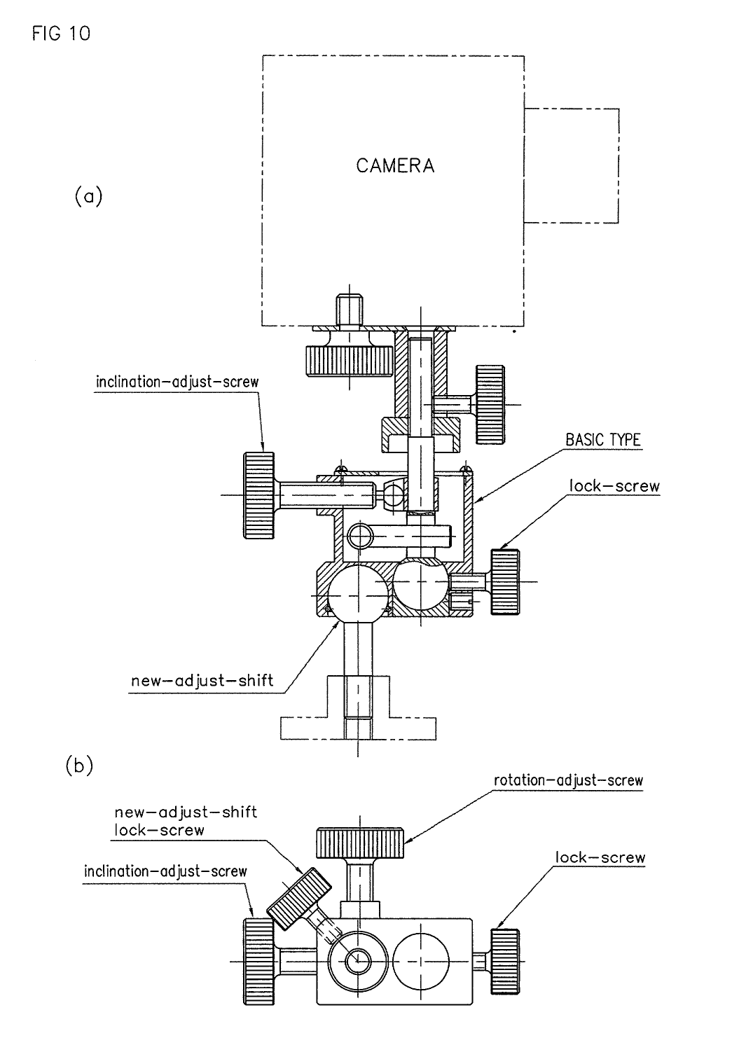

| | | | | | |
|---|---|---|---|---|---|
| 1 | Body | 1a | Hole | 1b | Spherical- |
| | | | | | surface |
| 1c | Stop-screw- | 1d- | Lock-screw | | |
| | hole | | hole | | |
| 1e | Side-wall of | | | 1f | screw-hole |
| | cavity of | | | | |
| | body | | | | |
| 1g | screw-hole | 1h | Screw-hole | | |
| | | | for Cover | | |
| 1i | screw-hole | 2 | Spherical- | 3 | Stop-screw |
| | | | cover | | |
| 4 | Lock-screw | 5 | Adjust-lever | 5a | Lever |
| 5b | Concave- | | | 5c | Ditch of |
| | spherical- | | | | stop-ring |
| | surface | | | | |
| 6 | Special- | 6a | Side-wall | 6b | Bearing-hole |
| | bearing | | | | |
| 6c | Open-hole | 6d | Arc-surface | 7 | Small-screw |
| 8 | Cover | 8a | Hole | 8 b | Long- |
| | | | | | elliptical- |
| | | | | | hole |
| 8c | Bottom of | 9 | Adjust-shaft | 9a | Sphere-head |
| | cover | | | | |
| 9b | Rectangular- | 9c | Shaft | 9d | Screw |
| | hole | | | | |
| 9e | Plane | 10 | Inclination- | 10a(12a) | Sphere-head |
| | | | adjust-screw | | |
| 10b(12b) | Neck | 11 | Stop-ring | 12 | Rotation- |
| | | | | | adjust-screw |

What I claim as my invention is:

1. The device is assembled as a body of rectangular parallelepiped. The upper part of the body of about ⅗ height is hollow. A through hole pieces the lower solid part of the body at the center of width. The upper part of the hole is made a shape of spherical surface. An important part of the device called adjust-shaft is a circular rod with one end in spherical shape which is called sphere head of adjust-shaft. Diameter of the sphere is large than diameter of the shaft. Insert the shaft with sphere downward into the body from below through the hole. The sphere head is in accordance with the spherical surface of the hole. Then, a spherical-surface-bottom-cover closes the hole from below and a stop-screw is used to fix the bottom-cover so that the sphere-head is localized in the body but it is able to turn within a limited scope in any direction. Most of upper part of the adjust-shaft stretches out of the body. There is a rectangular hole in the shaft rod remaining inside the body. An element of the device called adjust-lever is inserted into the hole from the side of the shaft. The adjust-lever is allowed to move up and down a little, but it is not allowed to move transversely. One end of the lever is made an open hollow concave curved surface to form an open hole. Another element of the device is called rotation-adjust-screw. End of the screw is formed a sphere and is given a name of the sphere-head. Diameter of the sphere head is smaller than inside diameter of the screw. There is a neck between the sphere head and screw diameter of the neck is about 2/5 of diameter of the sphere head. Dive the rotation-adjust-screw into the curved hole of the adjust-lever and localized the sphere head in the hole with a stop ring. During the rotation-adjust-screw makes the lever move forwards and backwards so that the adjust-shaft rotates within a limited scope.
Another element of the device is the special bearing. There are two holes in it. The adjust-shaft goes through one of them. The other is an open hole. The opening width is smaller than diameter of the cylindrical hole but is littler larger than the neck of the inclination-adjust-screw. The inclination-adjust-screw is of same structure with the rotation-adjust-screw. Drive the inclination-adjust-screw into the screw hole in the side wall of the body. The inclination-adjust-screw is located above the rotation-adjust-screw and they are perpendicular in direction of driving. Insert the special bearing fits width of the cavity. In the meantime the adjust-shaft is inserted through the bearing hole and the sphere-head of the inclination-adjust-screw is fitted into the open hole of the special bearing. They are all designed and manufactured fittingly. Thus, the adjust-shaft is able to make inclination movement along the interior sides of body wall as a result of pulling and pushing actions of the sphere head in the open hole of the special bearing when the inclination-adjust-screw is driven.
The cover is fixed on top of the body by small screws. The rectangular opening in the cover limits inclination scope of the adjust-shaft. The cover can also prevent the special bearing from getting free upward. The gap between top of the special bearing and bottom of the cover keeps unchanged when the special bearing is made an arc and center of the arc drawn by the adjust-shaft during its inclination movement. Within the definite scopes, the inclination-adjust-screw controls the adjust-shaft to incline left or right, and the rotation-adjust-screw controls the adjust-shaft to rotate. The two phases of movement can be achieved individually or simultaneously. This is the principal that ZWJ-ANGLE-ADJUSTMENT (Basic type) works on.

2. A new-adjust-shaft is installed to the body from opposite direction with adjust-shaft stated in item 1. The new-adjust-shaft has the same shape and structure with one stated above. Sphere-head of the new-adjust-shaft is fitted into a new spherical hole in the bottom of the body located near the adjust-shaft stated above. The new spherical hole is closed by a stop ring. The new adjust-shaft does not link with any adjust-screw and is operated manually. So the new-adjust-shaft can achieve a rotation range of 0°˜360° and inclination range of 0°˜120°. After preliminary adjustment brought about by the new-adjust-shaft is done, further accurate adjustment can be achieved by the basic type of ZWJ-ANGLE-ADJUSTMENT more quickly and easily. This is the principal that ZWJ-ANGLE-ADJUSTMENT (Compound type) works on.
